(19) United States
(12) Patent Application Publication
(10) Pub. No.: US 2012/0248955 A1
(43) Pub. Date: Oct. 4, 2012

(54) PULL-OUT GUIDE AND DOMESTIC APPLIANCE

(75) Inventors: Daniel Rehage, Bielefeld (DE); Timo Kaps, Werther (DE)

(73) Assignee: Paul Hettich GmbH & Co. KG, Kirchlengern (DE)

(21) Appl. No.: 13/504,497

(22) PCT Filed: Oct. 25, 2010
(86) PCT No.: PCT/EP2010/066051

§ 371 Date: Jun. 19, 2012

(30) Foreign Application Priority Data
Oct. 30, 2009 (DE) 20 2009 013 663.9

(51) Int. Cl. F24C 15/16; F16C 29/02; F16C 29/08

(52) U.S. Cl. 312/334.1; 384/15

(57) ABSTRACT

A pull-out guide for a domestic appliance. The pull-out guide includes a stationary guide rail and a running rail movably mounted on the stationary guide rail.

This application is a national stage of International Application PCT/EP2010/066051, filed Oct. 25, 2010, and claims benefit of and priority to German Patent Application No. 20 2009 013 663.9, filed Oct. 30, 2009, the content of which Applications are incorporated by reference herein.

### BACKGROUND AND SUMMARY

The present disclosure relates to a pull-out guide, for example, for domestic appliances. The pull-out guide includes a stationary guide rail on which at least one running rail is mounted in a moveable manner. The present disclosure also relates to a baking oven including a rack held by a pull-out guide.

DE 10 2004 019 102 discloses a pull-out system for a domestic appliance in which an immobile support rail and a moveable pull-out rail are provided.

In order for the pull-out system to have consistently good running properties, a coating is proposed. In the case of such telescopic extension rails, the problem is that cleaning the pull-out rails is cumbersome and is carried out only superficially. In addition, during a pyrolytic cleaning process, the metal rails tarnish and any adhering grime can burn itself onto them. This gives the impression that the rails are permanently dirty.

The present disclosure thus provides for a pull-out guide for use, for example, in domestic appliances and that allows for ease of cleaning.

Thus, embodiments of the present disclosure provide for a pull-out guide for a domestic appliance. The pull-out guide includes a stationary guide rail, a running rail movably mounted on the stationary guide rail, and a cover detachably coupled to and fitted around the running rail.

According to an embodiment of the present disclosure, for example, a heat-resistant, strip-shaped cover is detachably mounted around the running rail of the pull-out guide. This allows for easy cleaning of the surface of the pull-out guide by dismantling and removing the cover from the running rail in order, for example, to wash it in a dish washer. In addition, the cover can avoid tarnishing during the pyrolytic cleaning process, for example by an appropriate colouring of the cover and/or coating, and a potential tarnishing of the rails of the pull-out guide remains concealed. Furthermore, the cover avoids the pull-out guide becoming impaired by dirt particles, especially in regard to the running properties of the pull-out according to the present disclosure.

To protect the rails of the pull-out guide from grime and to ensure ease of installation, the cover may be, for example, arranged around the running rail in a U-shape. Thus, it is within the scope of the present disclosure for the cover to overlap a slot between the guide rail and the running rail, so that no dirt can enter in between the rails. The cover can, thereby, engage at least partially around the guide rail in order to protect the guide rail from grime or tarnishing during a pyrolytic cleaning process. And, the cover is configured to conceal the tarnishing of the pull-out guide, thereby providing the user with a visually pleasing view of the pull-out system.

To avoid the cover being unintentionally released from the running rail, the cover is held on the running rail by, for example, fastening means. The cover can, in accordance with the present disclosure, be fixed in a non-positive and/or form-fitted manner via detent means, clamping means, screws or other fasteners.

The cover may, for example, be made of curved sheet metal and/or from plastic, wherein the surface is so constructed to make easy cleaning possible. The cover can, within the scope of the present disclosure, be layered with a coating. The coating can be dyed in order to attain a visually attractive impression for the user. Furthermore, the coating may be designed for a temperature range of between −50° C. to 600° C., such as, for example, an organic-inorganic hybrid polymer layer. Furthermore, for example, PEEK coatings (PolyEtherEtherKetone) and/or PTFE coatings (Polytetrafluoroethylene) can be applied. The coating improves the cleanability, increases scratch resistance and reduces or even prevents the corrosion of the cover. Combinations of different coatings are within the scope of the present disclosure.

According to a further embodiment of the present disclosure, the cover forms a stop at a front-end of the cover. The stop abuts the guide rail and/or a middle rail when in an end position, for example, in the retracted position. This makes it possible, within the scope of the present disclosure, to dispense with a further stop on the rails of the pull-out guide in the closing direction.

The cover may, within the scope of the present disclosure, be fixed at opposite end sections on an upper surface by fastening means that partially project upwards and form a stop for a cooking rack, for example. This allows the fastening means to have a double function. The fastening means may, for example, be formed as a thumbscrew to enable a tool-free assembly and disassembly.

With a direct attachment of the cover on the running rail, fastening means may be, for example, provided to emerge out of the cover and be connected to the running rail in the form of a detent connection. In order to enable a positional fixing of the cooking rack on the cover, stops may, in accordance with the present disclosure, be provided to emerge from the cover.

The at least one running rail can, for example, be guided linearly over rollers, sliders or other guide arrangements on the guide rail. The structure of the pull-out guide, according to embodiments of the present disclosure, is configured to not interfere with the use of the cover.

When using the cover, according to the present disclosure, as a stop for the guide rail in the closed state, the pull-out guide according to the present disclosure, is configured to be employed without additional stops for the closed position.

The pull-out guide with its cover, in accordance with the present disclosure, may be advantageously used in other domestic appliances, for example, such as refrigerators.

According to the present disclosure, a baking oven may be provided in which at least one cooking rack is held at opposite sides on a pull-out guide according to the present disclosure. Such pull-out guides can, thereby, in accordance with the present disclosure, be mounted on a side grid within the baking oven.

Other aspects of the present disclosure will become apparent from the following descriptions when considered in conjunction with the accompanying drawings.

### BRIEF DESCRIPTION OF THE DRAWINGS

FIG. 1 shows a perspective view of a cooking rack arranged in a baking oven, the cooking rack being supported on opposite sides on pull-out guides with covers, according to the present disclosure.

FIG. 2 shows a perspective view of the pull-out guide, of FIG. 1 according to the present disclosure, mounted on a side grid.

FIG. 3 shows a perspective view of the pull-out guide of FIG. 2 in an extended position.

FIG. 4 shows a perspective exploded view of the pull-out guide of FIG. 3.

FIG. 5 shows a perspective view of the pull-out guide of FIG. 3 in a retracted position.

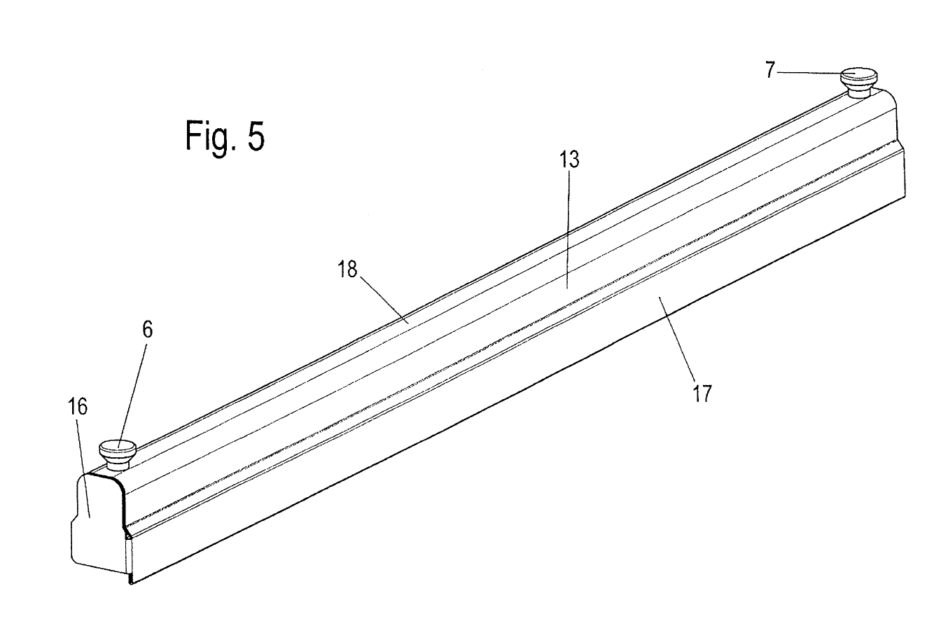

FIG. 6 shows a perspective view of an underside of the cover of the pull-out guide of FIG. 3.

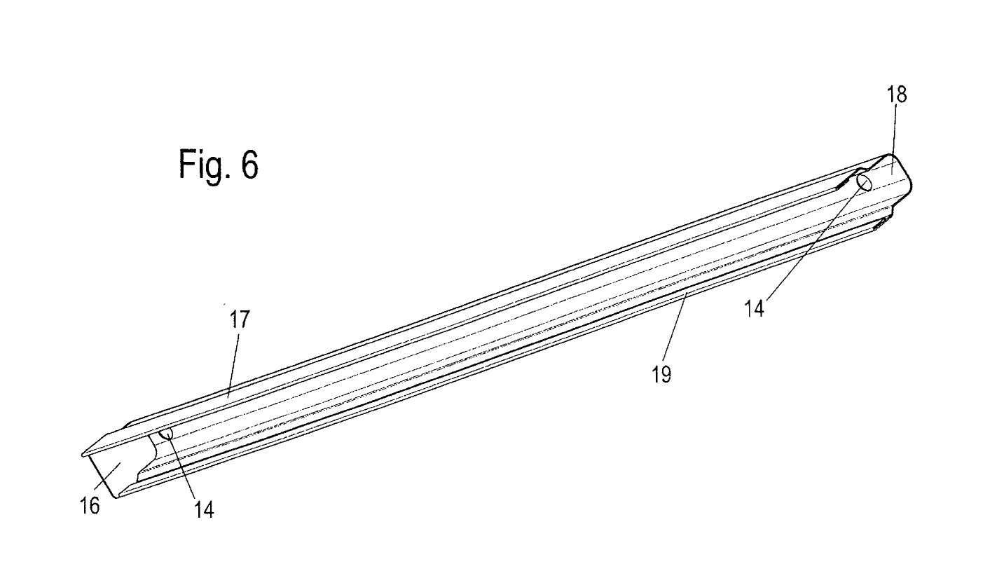

FIGS. 7A and 7B show two views of the pull-out guide of FIG. 3 before a retracted position.

FIGS. 8A and 8B show two perspective views of the pull-out guide of FIG. 3 in a retracted position.

### DETAILED DESCRIPTION

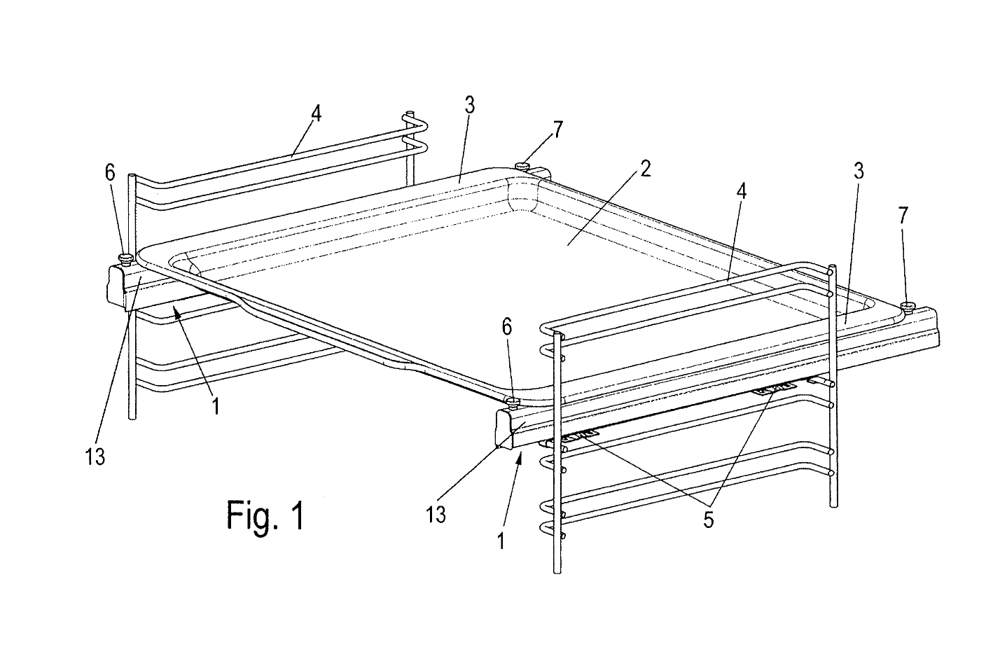

FIG. 1 shows components in an interior chamber of, for example, a baking oven. A cooking rack 2, in the form of a baking tray, is supported on two laterally arranged pull-out guides 1. An edge section 3 of the cooking rack 2 lies on a cover 13 on the pull-out guide 1. The pull-out guides 1 are fixed at a side grid 4 by, for example, retaining clips 5.

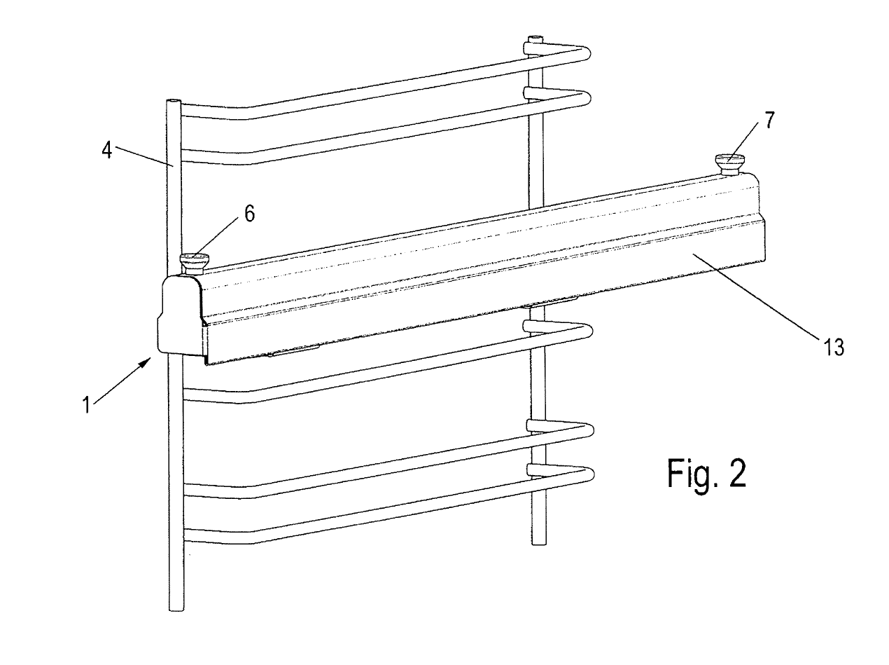

In order to avoid a displacement of the cooking rack 2 on the pull-out guides 1, provided adjacent to the respective edge sections 3 are upwardly projecting fastening means 6 and 7 that are, for example, configured as knurled nuts or knurled screws. As shown in FIG. 2, the fastening means 6 and 7 are arranged at an upper side of the pull-out guide 1.

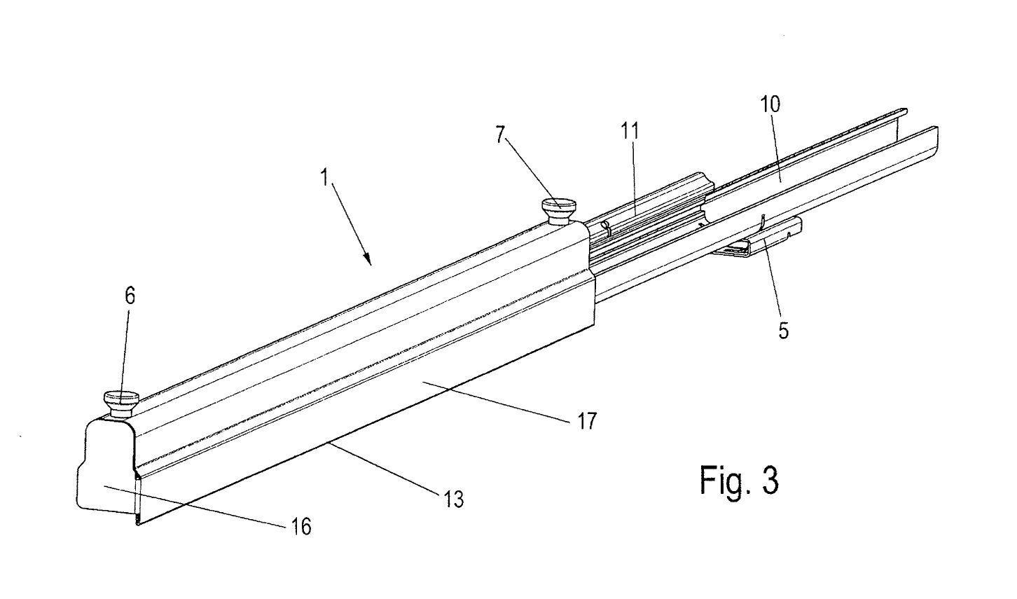

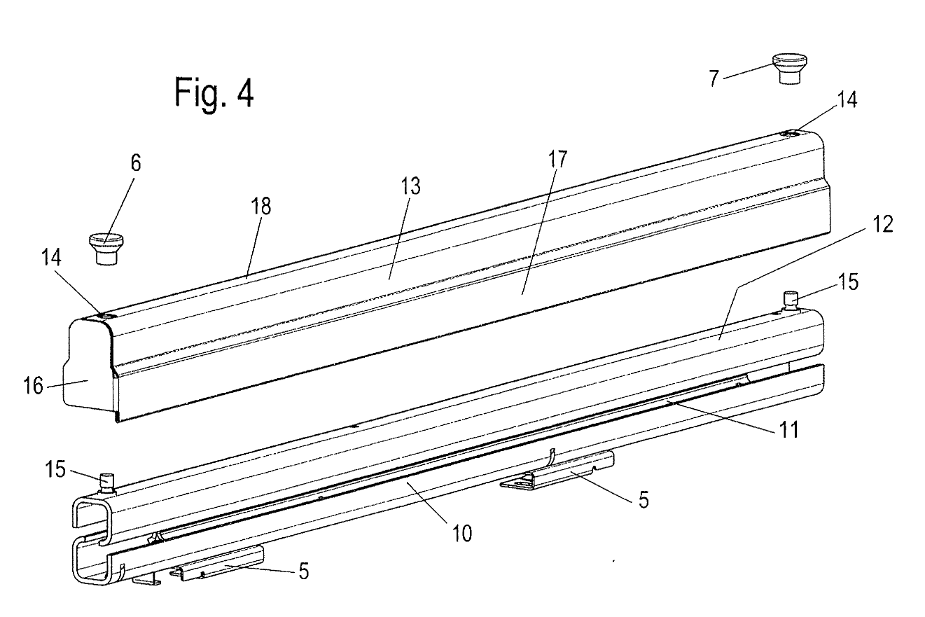

FIG. 3 shows a pull-out guide 1 in an extended position so that the cooking rack 2 would be arranged in a front of the baking oven. The pull-out guide 1 includes a guide rail 10 arranged in a stationary manner. The guide rail 10 is fixed by retaining clips 5 at a side grid 4. On the guide rail 10, moveably supported by rolling elements, there is a middle rail 11 that moveably holds a running rail 12 by rolling elements, as shown or suggested in FIG. 4. The guide rail 10 and the running rail 12 are, for example, configured as U-shaped profiles, wherein one leg is formed longer and at an end section is curved inwards. Between the running rail 12 and the guide rail 10, the middle rail 11 is arranged in a concealed manner.

On the running rail 12, on an upper side at opposite ends, there are upwardly protruding and fixed fastening bolts 15 that serve the purpose of attaching, for example, a strip-shaped cover 13. The strip-shaped cover 13 may include, for example, a curved piece of sheet metal or plastic and may have a U-shaped cross section. At an upper middle section 18, openings 14 are provided at opposite end sections. The openings 14 are penetrated by the fastening bolts 15. The fastening bolts 15 can be fitted with a thread or other fastening aids in order to attach the upwardly protruding fastening means 6 and 7, by, for example, knurled nuts. Thus, the cover 13 is attached to the guide rail 12 in a clamping fashion. The cover 13 has a leg 17 at a side facing the cooking rack 2, whereby, in the assembled position, leg 17 covers the running rail 12 as well as the guide rail 10 and protrudes downwards. Consequently, the guide rail 10 and, to a certain extent, the retaining clips 5, are arranged in a protected manner. Furthermore, the slot between the running rail 12 and the guide rail 10 is protected from soiling from within an interior chamber of the baking oven.

The cover 13 is U-shaped in cross-section and includes longer inside leg 17 and an outside leg 19 that extends to the retaining clip 5. The cover 13 can be coated on the outside, for example, with a heat-resistant paint, so that light cleaning is made possible.

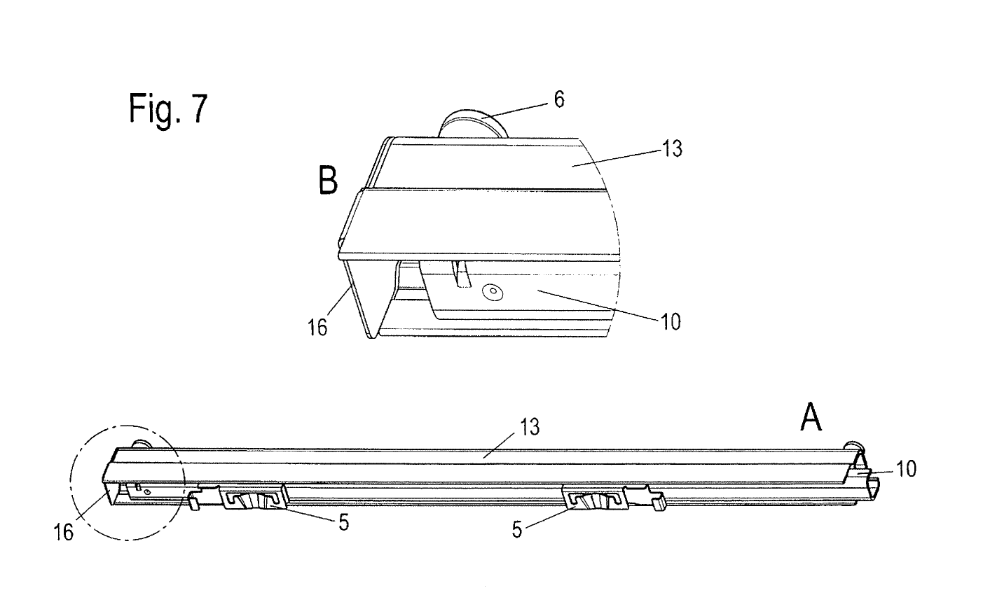

At one end, the cover 13 has a closed front side 16 that, on the one hand, offers protection from soiling and, on the other hand, serves as a stop. In FIGS. 7A and 7B, the pull-out guide 1 is shown in a position just before the retracted position, wherein the cover 13 mounted on the running rail 12 is arranged with the front side 16 at a slight distance from the guide rail 10.

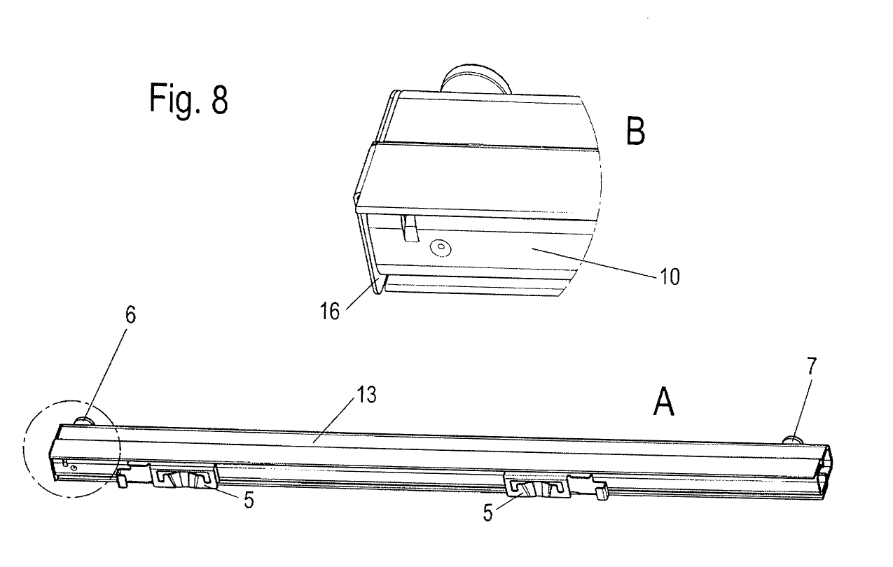

When the running rail 12 is moved into the end position, as shown in FIGS. 8A and 8B, the front side 16 abuts the stationary guide rail 10 and prevents a further retraction of the running rail 12.

For cleaning, the two fastening means 6 and 7, for example, in the form of knurled nuts or knurled screws, are configured to be released in order to then remove the cover 13 in an upwards motion. The cover 13 can then be cleaned and remounted onto the running rail 12.

Although the present disclosure has been described and illustrated in detail, it is to be clearly understood that this is done by way of illustration and example only and is not to be taken by way of limitation. The scope of the present disclosure is to be limited only by the terms of the appended claims.

We claim:

1. A pull-out guide for a domestic appliance, the pull-out guide comprising:
a stationary guide rail:
a running rail movably mounted on the stationary guide rail; and
a cover detachably coupled to and fitted around the running rail.

2. The pull-out guide according to claim 1, wherein the cover encloses the running rail in a U-shaped manner.

3. The pull-out guide according to claim 1, wherein the cover overlaps a slot located between the guide rail and the running rail.

4. The pull-out guide according to claim 1, wherein the cover at least partially surrounds the guide rail.

5. The pull-out guide according to claim 1, wherein the cover is coupled via fastening means on the running rail.

6. The pull-out guide according to claim 5, wherein the fastening means includes screws.

7. The pull-out guide according to claim 5, wherein the cover fastening means is configured to be one or both of form-fitted to and integral with the running rail.

8. The pull-out guide according to claim 1, wherein the cover is made from a curved piece of one or both of sheet metal and plastic.

9. The pull-out guide according to claim 1, wherein the cover is at least partially layered with a coating on an outside of the cover.

10. The pull-out guide according to claim 1, wherein the cover includes a front side and at the front side, a stop is formed that rests in an end position on one of the guide rail and a middle rail.

11. The pull-out guide according to claim 5, wherein the cover includes an upper side that is fixed at opposing end sections by the fastening means, which fastening means partially protrude upwards and form a stop for a rack of the domestic appliance.

12. The pull-out guide according to claim 1, wherein the cover, at an inner side, protrudes downwards over the guide rail.

13. A baking oven, wherein the baking oven includes a cooking rack that is held on opposite sides of the baking oven by a pull-out guide according to claim 1.

14. A cover for the pull-out guide according to claim 1.

15. The pull-out guide according to claim 1, wherein the cover is strip-shaped.
